(19) United States
(12) Patent Application Publication
(10) Pub. No.: US 2023/0177116 A1
(43) Pub. Date: Jun. 8, 2023

(54) NEURAL NETWORK SYNTHESIZER

(71) Applicant: Arm Limited, Cambridge (GB)

(72) Inventors: Vasileios LAGANAKOS, Essex (GB); Mark Richard NUTTER, Austin, TX (US)

(21) Appl. No.: 17/649,277

(22) Filed: Jan. 28, 2022

(30) Foreign Application Priority Data
Dec. 7, 2021 (EP) 21386075.2

(51) Int. Cl. G06K 9/62; G06N 3/08; G06N 3/04

(52) U.S. Cl. CPC G06K 9/6262; G06K 9/6201; G06N 3/08; G06N 3/0454

(57) ABSTRACT

A computer-implemented method includes obtaining trained neural networks for performing a common task and test data for evaluating the performance of the trained neural networks, and inspecting the trained neural networks to identify functional blocks common to a plurality of the trained neural networks. For each identified functional block, extracting a respective network component for implementing the functional block within each of at least some of the trained neural networks, and for each extracted network component, evaluating performance of the network component, and storing performance data indicating said performance of the network component. Storing configuration data indicating a configuration of the identified functional blocks, receiving a request to synthesize a neural network for performing said task subject to a given set of constraints, and composing a plurality of network components in accordance with the configuration data and in dependence on the performance data and the given set of constraints.

### CROSS-REFERENCE TO RELATED APPLICATIONS

This application claims priority pursuant to 35 U.S.C. 119(a) to European Patent Application No. 21386075.2, filed Dec. 7, 2021, which application is incorporated herein by reference in its entirety.

### FIELD OF THE INVENTION

The present disclosure relates to synthesizing a neural network for performing a given task subject to a set of constraints. Embodiments described herein have particular, but not exclusive, relevance to synthesizing a neural network for performing a given task on specified hardware.

### DESCRIPTION OF THE RELATED TECHNOLOGY

Growing research interest in the field of deep learning, along with increased availability of specialist hardware such as graphics processing units (GPUs), has led to a sharp rise in the deployment of neural networks across a wide range of use cases. As a result, large numbers of trained neural networks and test data are freely available for many ubiquitous tasks, including image analysis tasks such as object detection, depth extraction, time series analysis, and various other classification and regression tasks.

Many neural networks have large memory footprints and are highly demanding of compute power and time, both during training and when deployed. As a result, many existing neural networks are unsuitable for implementing on low power devices, such as mobile devices or Internet of Things (IoT) devices. Generating and training new neural networks from scratch, suitable for running on such devices, is highly resource- and time-consuming due to the facilities and resources required both to train a neural network and to create training, validation, and test data sets. The developing fields of knowledge distillation and model compression attempt to address these issues by transferring “knowledge” encoded within a large, trained model to a smaller, less expensive model, without loss of validity.

### SUMMARY

According to a first aspect, there is provided a computer-implemented method. The method includes obtaining a set of trained neural networks for performing a common task and test data for evaluating the performance of the trained neural networks in the set when performing said task. The method includes inspecting the trained neural networks in the set to identify a plurality of functional blocks each common to a plurality of the trained neural networks in the set. For each identified functional block, the method includes extracting a respective network component for implementing the functional block within each of at least some of the trained neural networks, and for each extracted network component, evaluating performance of the network component when processing the test data, and storing performance data indicating said performance of the network component when processing the test data. The method further includes storing configuration data indicating a configuration of the identified plurality of common functional blocks within said plurality of the trained neural networks, receiving a request to synthesize a neural network for performing said task subject to a given set of constraints, and composing a plurality of network components in accordance with the stored configuration data and in dependence on the performance data and the given set of constraints, thereby to synthesize a neural network in accordance with the received request.

According to a second aspect, there is provided a computer-implemented method. The method includes reading, from one or more memory devices: configuration data indicating a configuration of a plurality of functional blocks common to a plurality of neural networks for performing a task; and for at least one functional block of said plurality of functional blocks, performance data for one or more network components for implementing said functional block, the performance data for the or each network component indicating a performance of said network component when performing said task. The method includes receiving a request to synthesize a neural network for performing said task subject to a given set of constraints, and selecting, for each functional block of said plurality of functional blocks, a network component for implementing said functional block, wherein the selecting for said at least one functional block is dependent on the given set of constraints and the performance data for the one or more network components for implementing said functional block. The method includes reading, from one or more memory devices, network component data representing the selected network components, and using the network component data to compose the selected network components in accordance with the configuration data, thereby to synthesize a neural network in accordance with the received request.

According to a third aspect, there is provided a non-transient storage medium comprising computer-readable instructions which, when executed by a computer, cause the computer to perform a method including obtaining a set of trained neural networks for performing a common task and test data for evaluating the performance of the trained neural networks in the set when performing said task, and inspecting the trained neural networks in the set to identify a plurality of functional blocks common to a respective plurality of the trained neural networks in the set. For each identified functional block, the method includes extracting a respective network component for implementing the functional block within each of at least some of the trained neural networks, and for each extracted network component, evaluating performance of the network component when processing the test data and storing performance data indicating said performance of the network component when processing the test data. The method further includes storing configuration data indicating a configuration of the identified plurality of common functional blocks within said plurality of the trained neural networks.

Further features and advantages will become apparent from the following description of embodiments, given by way of example only, which is made with reference to the accompanying drawings.

### BRIEF DESCRIPTION OF THE DRAWINGS

FIG. 1 is a schematic block diagram of a neural network synthesizer according to examples;

FIG. 2 schematically shows functionally corresponding blocks in a set of neural networks;

FIG. 3 is a flow diagram representing a method of synthesizing a neural network according to examples;

FIG. 4 illustrates a method of identifying functionally corresponding blocks in a set of neural networks; and,

FIG. 5 is a schematic block diagram of a further neural network synthesizer according to examples.

### DETAILED DESCRIPTION OF CERTAIN INVENTIVE EMBODIMENTS

Details of systems and methods according to examples will become apparent from the following description with reference to the figures. In this description, for the purposes of explanation, numerous specific details of certain examples are set forth. Reference in the specification to ‘an example’ or similar language means that a feature, structure, or characteristic described in connection with the example is included in at least that one example but not necessarily in other examples. It should be further noted that certain examples are described schematically with certain features omitted and/or necessarily simplified for the ease of explanation and understanding of the concepts underlying the examples.

Embodiments of the present disclosure relate to synthesizing neural networks. In particular, embodiments described herein address challenges relating to the implementation of neural network models on specific hardware, and the high demands on resources and time resulting from training different neural network models from scratch for different types of hardware.

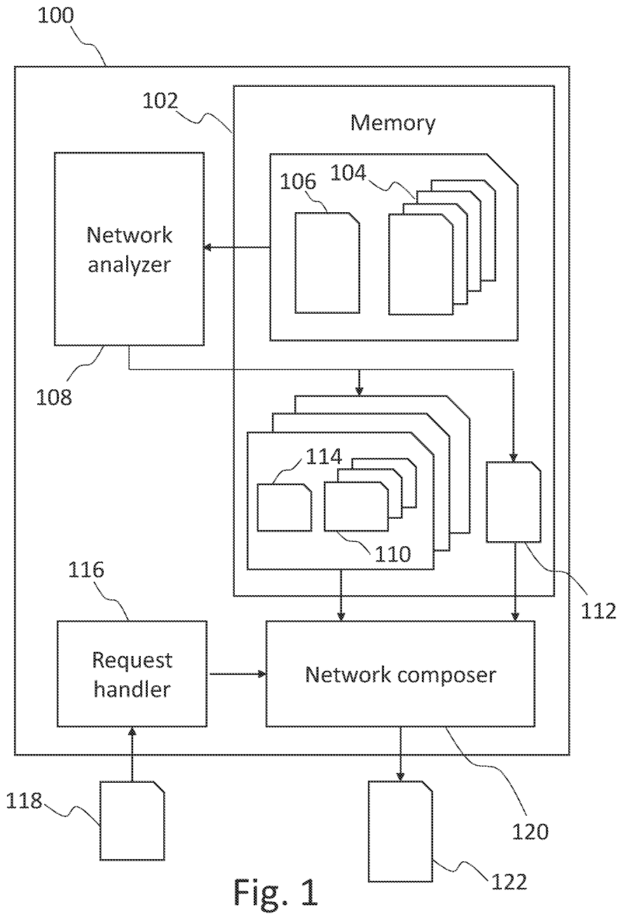

FIG. 1 schematically shows functional components of a neural network synthesizer 100 in accordance with examples. The various functional components shown in FIG. 1 may be implemented using software, hardware, or a combination of both. The neural network synthesizer 100 includes memory 102, which in the present disclosure is refers both to non-volatile storage and to volatile and non-volatile working memory. The memory 102 is arranged to store input data including a set of trained neural networks 104 and test data 106 for evaluating the performance of the trained neural networks 106. In the present disclosure, the performance of a neural network refers to any quantifiable characteristic(s) associated with the processing of input data by the neural network, including for example accuracy, memory footprint, number of processing operations, energy usage, latency, and so on. Evaluating the performance of the neural network refers to measuring or estimating values of one or more of these performance characteristics when the neural network is used to process input data. Some performance characteristics, such as memory footprint, may be evaluated by inspecting the neural network in the absence of input data, whereas other performance characteristics, such as accuracy, may be evaluated only when input data is available. Each of the trained neural networks has a specified architecture, along with trainable parameters whose values have been determined using machine learning and a respective set of training data. The trained neural networks 104 typically have different architectures and trainable parameters, but at least some of the neural networks 104 in the set belong to a common class and subclass. In the present disclosure, neural networks in a given class are configured to perform a common task such as image classification or regression, per-pixel estimation, depth estimation, auto-encoding, and so-on, whereas neural networks in a given subclass have been trained to target a specific domain, such as facial recognition, covid-19 detection, depth estimation for autonomous vehicles, etc. Other tasks include, but are not limited to, classification and regression of various types of input data, such as time-series data, text data, or audio data. The set of neural trained network 104 may exclusively contain neural networks from a given subclass, or neural networks from a given class but several subclasses, or neural networks from multiple classes. One or more sets of test data is stored for each subclass of the trained neural networks. The test data may be distinct from the training data on which any of the neural networks is trained, and includes any necessary metadata e.g. labels, for evaluating the performance of neural networks in the subclass.

The neural network synthesizer 100 includes a network analyzer 108. For each subclass of the trained neural networks, the network analyzer 108 is arranged inspect the stored neural networks of that subclass, in order to identify functional blocks common to at least some of those neural networks. Functional blocks within a neural network produce a given output when faced with a given input during processing of data. Functional blocks common to two or more neural networks may be identified as those that consistently produce a similar output to one another (within a given tolerance, potentially up to a scaling and/or a reordering of channels in the case of an input/output with multiple channels) when faced with the same inputs. For example, a common functional block for the class of image classification may detect edges within an image. A further common functional block for the subclass of facial recognition may identify eyes based on a set of detected edges. The functions performed by other functional blocks may be esoteric or difficult for any human to understand, but nevertheless may be found commonly in at least a subset of neural networks within a class and/or subclass. Each of the neural networks within a subclass sharing a common functional block will have a corresponding network component for implementing that functional block. In the present disclosure, a network component refers to a contiguous portion of a neural network having an input layer, and output layer, and optionally one or more hidden layers or other processing units disposed between the input layer and the output layer. For example, a network component may be a contiguous group of layers, or may consist of a single layer (in which case the input layer is also identified as the output layer).

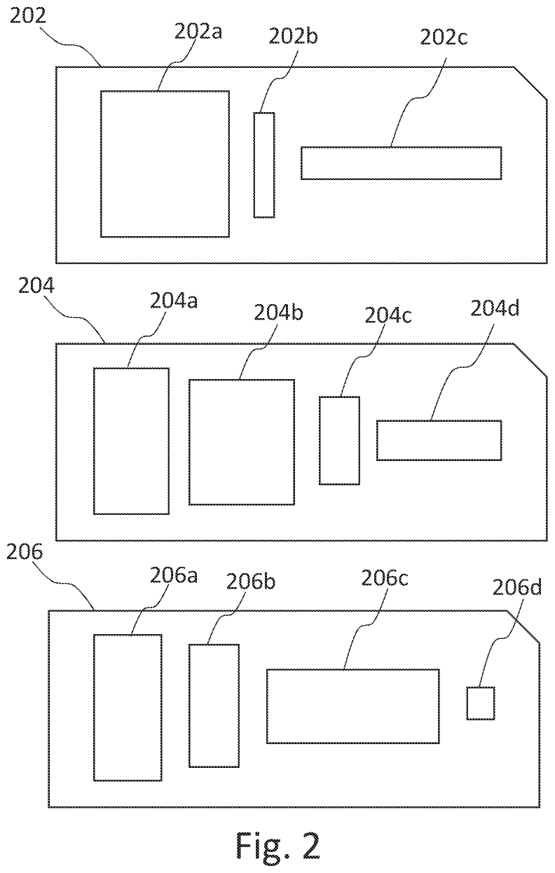

FIG. 2 shows three trained neural networks 202, 204, 206 from a common class and subclass. The networks 202, 204, 206 are arranged to perform the same task as one another, i.e. a common task (for example, depth estimation) on the same type of input data, i.e. a common type of input data (for example, image data). The networks 202, 204, 206 may have differing performance characteristics in terms of e.g. accuracy, memory footprint, compute cost, latency and execution time. Various functional blocks are identified as common to the networks 202, 204, 206. A first functional block is implemented by a network component 202a in the network 202, a network component 204a in the network 204, and a network component 206a in the network 206. A second functional block is implemented by a network component 202b in the network 202, a network component 204b in the network 204, and a network component 206b in the network 206. Despite performing a common function, the properties of the network components implementing these functional blocks may be different. For example, the different network components may include a different number of layers (i.e. have a different depth), a different numbers of neurons per layer (i.e. have a different width), a different orderings of layers and/or different types of layers. The different properties of the network components are represented in FIG. 2 by the corresponding network components between the networks 202, 204, 206 having different shapes to one another.

It is possible that a functional block common to a number of trained neural networks is composed of further functional blocks which are common to some, but not all, of those neural networks. In the example of FIG. 2, a third functional block is implemented by a network component 202c in the network 202, by a composite network component 204c+204d in the network 204, and by a composite network component 206c+206d in the network 206. Fourth and fifth functional blocks are identified as components of the third functional block. However, the fourth and fifth functional blocks are common to the networks 204 and 206, but not the network 202. The fourth (fifth) functional block is implemented by the network component 204c (204d) in the network 204, and by the network component 206c (206d) in the network 206.

Returning to FIG. 1, for each identified common functional block, the network analyzer 108 is configured to extract corresponding network components 110 within the neural networks that include that common functional block. The network analyzer 108 may for example copy data defining the corresponding network components 110 to a specific region of the memory 102, or alternatively may store index data identifying the network components 110. The network analyzer 108 is further arranged to store configuration data 112 indicating a configuration of the identified common functional blocks within the neural networks sharing those functional blocks. The configuration of the functional blocks includes at least the order of the functional blocks, and may further include information regarding connectivity between the functional blocks. The network analyzer 108 is further arranged to generate and store performance data 114 indicating performance characteristics of the corresponding network components 110 when processing the test data 106.

The neural network synthesizer 100 includes a request handler 116 arranged to receive and parse a request 118 for a synthesized neural network within a given class and subclass, subject to given constraints. The request handler 116 may include a user interface via which a user can input request data, and/or may include a network interface for receiving request data from a remote system (for example where the network synthesizer 100 is implemented as a server system). The request 118 may indicate a given class and subclass of neural network (though this may be implicit), along with one or more constraints to be satisfied by the neural network. The constraints may include, for example, memory constraints specifying a maximum memory footprint of the neural network, processing constraints specifying a maximum number of processing operations to be performed during execution of the neural network, or additionally/alternatively latency constraints or energy constraints when the neural network is executed using given hardware. Processing constraints related to specific hardware may be converted into constraints on memory and/or processing operations based on data stored on the specific hardware (for example, a lookup table or function for mapping values of latency and/or energy usage to numbers of processing operations for a given device or device type, or for a given combination of processor(s) and memory). The constraints may further include accuracy constraints, for example requiring a given performance level with respect to a given accuracy metric when the test data 106 is processed using the neural network.

The neural network synthesizer 100 includes a network composer 120, which is arranged to compose a set of network components 110 in a configuration determined by the configuration data 112, in dependence on the request 118 received at the request handler 116 and the performance data 114, thereby to generate a neural network 122 within the requested class and subclass, which satisfies the constraints specified in the request 118.

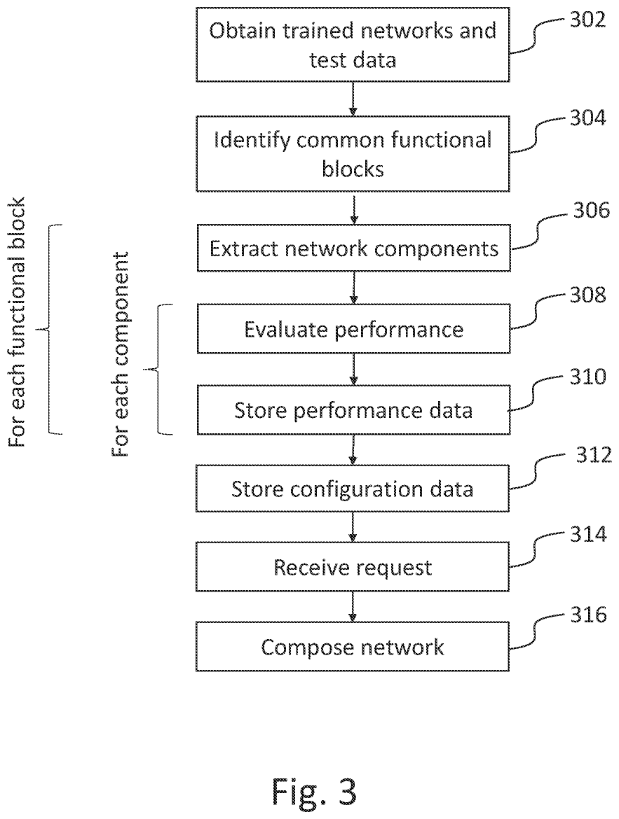

FIG. 3 shows an example of a method performed by the neural network synthesizer 100 for synthesizing a neural network for performing a given task subject to a given set of constraints. The neural network synthesizer 100 obtains, at 302, the set of trained neural networks 104 and the test data 106 for evaluating the performance of the trained neural networks 104. The trained neural networks 104 may be obtained from any suitable source, for example an online repository of trained neural networks or by training neural networks from scratch. Similarly, the test data 106 may be obtained from an online repository or any other suitable source. The network analyzer 108 of the neural network synthesizer 100 identifies, at 304, functional blocks common to at least some of the trained neural networks 104, and indexes or otherwise extracts the corresponding network components 110 of those trained neural networks at 306.

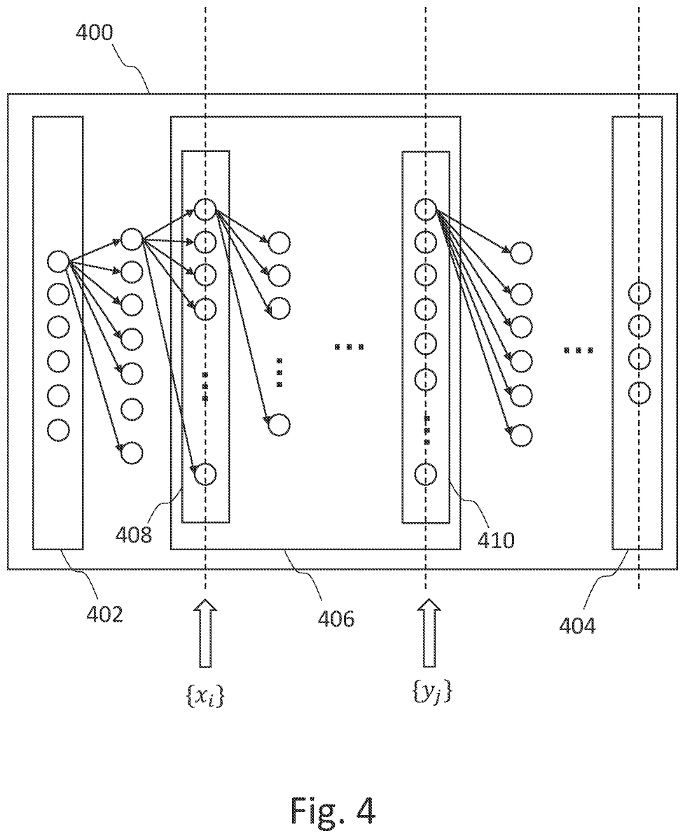

FIG. 4 illustrates a method of identifying functional blocks common to two or more trained neural networks. As shown, a trained neural network 400 has an input layer 402, an output layer 404, and a number of hidden layers (some of which are shown) arranged between the input layer 402 and the output layer 404. The input layer 402 is configured to receive input data (for example, test data) and the output layer 404 is configured to generate one or more output values relevant to the task at hand. Each of the layers of the neural network 400 includes a number of neurons (schematically shown as white circles in FIG. 4), is connected to any preceding and/or subsequent layer by one or more connections (some of which are shown schematically as straight black arrows in FIG. 4), and is parameterized by a number of trained parameters (such as weight values, biases, kernel weights, and so on). The layers may include any types of neural network layer, including fully connected layers, convolutional layers, pooling layers, recurrent layers and so on, and at least some of the layers may include respective activation functions. In the present disclosure, the term “layer” is intended to be interpreted broadly as a collection of neurons or nodes operating together at a specific depth within a neural network to generate an output, irrespective of their connectivity and complexity. During processing of a given data item by the neural network 400 (or given each processing cycle e.g. in the case of a recurrent neural network), each of the neurons within each layer will have a given activation. The activations of the neurons within each layer resulting from a given data item being input to the neural network 400 may be recorded, enabling the resulting instance of the neural network 400 to be viewed as a static graph. By processing the same data item with several neural networks, multiple graphs may be obtained which can be compared to determine common functional blocks as described in more detail hereafter.

FIG. 4 shows a neural network component 406 arbitrarily selected from within the neural network 400. The component 406 has an input layer 408 and an output layer 410, and in this case several layers between the input layer 408 and the output layer 410. The component 406 may be considered a mathematical function F for mapping a set of input activations {xᵢ} to a set of output activations {yⱼ}, i.e. F: {xᵢ}→{yⱼ}. Alternatively, a network component may be defined to include weights of connections arriving at the input layer and/or leaving the output layer, e.g. F: {xᵢ, wᵢ}→{yᵢwⱼ}. Different network components may be defined by selecting different input layers and output layers (i.e. by moving the positions of the white arrows in FIG. 4 to the left and right). According to the present example, a common test data item is input to several neural networks in the same subclass, including the neural network 400, and the resulting activations at each layer are recorded. The activations (and optionally, weights) of the layers are then compared between the neural networks to identify respective layers of the neural networks in the subclass which have similar activations to one another (for example, leading to a difference metric below a predetermined tolerance). Groups of layers between the networks which consistently have similar activations (for example, differing by less than a predetermined threshold) when different test data items are input to the networks are indexed, and neighboring pairs of indexed layers within each such network are identified as delimiting a network component for implementing a common functional block. The comparing of layer activations between networks may be performed systematically for example using a grid search, or may be performed using a random search. Other strategies for searching may be used, for example based on meta-learning. In some examples, normalization such as rescaling of layers and/or extracting or reordering channels within the layers may be performed during the comparison to ensure that functionally corresponding layers are not missed due to trivial differences. An advantage of performing comparisons when processing test data items is that the layers are tested only within the relevant domain of application of the neural networks, and are not compared for activations which have little or no chance of appearing during deployment of the neural networks.

Although in the example described above, common functional blocks are identified by inputting common data items into multiple neural networks, other methods may be used for identifying common functional blocks. For example, common input values may be fed into layers from several different neural networks. The common input values may for example be randomly generated values or any other suitable values. Activations of subsequent layers may then be compared, for example systematically, to identify common outputs. Groups of contiguous layers within the different neural networks that for a common set of input values result in a common set of output values (within a given tolerance) are identified as implementing a common functional block.

Having identified the functional blocks and indexed/extracted the corresponding network components 110, the neural network synthesizer 100 evaluates, at 308, the performance of each of the network components for implementing each functional block with respect to a predetermined set of performance metrics. The performance metrics may measure, for example, the number of operations performed by each identified network component, the time taken to execute the component, the memory footprint of the component, and so on. Certain aspects of the performance, such as number of processing operations and memory constraints, may be determined or estimated directly from the number and configuration of neurons in the network. The performance metrics may further indicate the effect of a given network component on accuracy. This may be estimated, for example, by evaluating the accuracy of the neural networks sharing a common functional component, interchanging the corresponding network components (which may include rescaling, reordering channels, and so on as described before), and measuring the effect on the accuracy of the neural networks. The accuracy of each of the neural networks may be evaluated using each of the corresponding network components, and the average effect on the accuracy for each network component recorded. Other effects on the outputs of the neural networks may also be stored. The neural network synthesizer stores, at 310, performance data 114 indicating the performance of the network components 110.

The neural network synthesizer 100 stores, at 312, the configuration data 112 indicating the configuration of the identified common functional blocks within the neural networks sharing those common functional blocks. The configuration data 112 includes at least the ordering of the functional blocks for implementing a given subclass. The configuration data 112 may further include information relevant to the connectivity, for example by imposing a scaling and/or ordering of channels at the input/output of each layer, to enable network components to be composed as will be described in more detail hereinafter.

The neural network synthesizer 100 receives, at 314, the request 118 via the request handler 116. As discussed above, the request 118 indicates a class and subclass of neural network, along with a set of constraints. The network composer 120 selects a combination of the network components 110 in accordance with the configuration data 112, using the performance data 114 to determine which combination(s) of network components, if any, are expected to satisfy the constraints. If more than one such combinations exists, the network composer 120 may for example select the combination which is expected to achieve the highest accuracy, the lowest computational cost or memory footprint, etc. The request 118 may include a list of multiple constraints ordered from most important to least important. For example, if the neural network synthesizer is used to synthesize a neural network for implementation on hardware with specific memory requirements, then memory footprint may be specified as the most important constraint. If several combinations of network components are identified which are expected to satisfy the memory constraint, then the neural network synthesizer may determine which of the identified combinations, if any, is expected to satisfy the next most important constraint, and so on through the list of constraints, with each subsequent constraint potentially reducing the number of suitable combinations. If a combination of network components is identified which is expected to satisfy the most important constraint(s), but which fails to satisfy one or more of the less important constraints, then the network composer 108 may select this combination and optionally notify the user that the less important constraint(s) are not met. The network composer 108 synthesizes the neural network 122 by composing the selected combination of network components at 316, in accordance with the stored configuration data. Optionally, the neural network synthesizer 100 may test the performance of the synthesized network 122 to determine whether the constraints are actually satisfied. If the constraints are determined to be satisfied, the neural network synthesizer 100 may output the neural network 122. If the constraints are not determined to be satisfied, an alert may be raised indicating that the synthesized network 122 does not satisfy the constraints, and to what extent. If training data and/or validation data is available for the given task, the neural network synthesizer 100 may perform conventional machine learning to refine the neural network 122. It is to be noted that, even in cases where the synthesized neural network 122 does not achieve a required level of performance (for example, in terms of accuracy), training the synthesized neural network 122 from the starting point of the composed network components is expected to be significantly less demanding on time and resources than training a new neural network from scratch (which would also require model selection including hyperparameter selection and architecture selection).

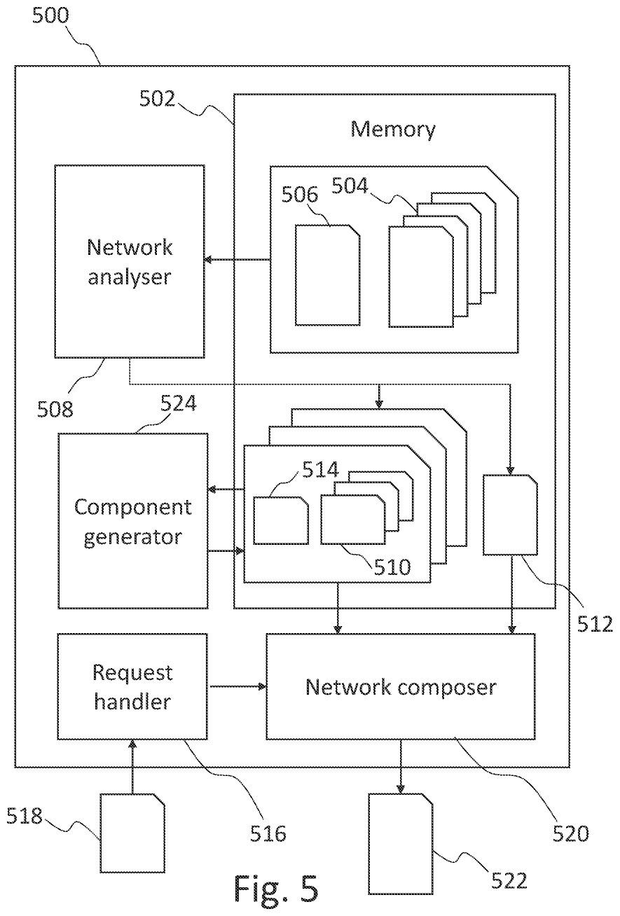

FIG. 5 shows a neural network synthesizer 500 which has corresponding components to the neural network synthesizer 100 of FIG. 1, with corresponding components having identical reference figures (mod 100). The neural network synthesizer 500 further includes a component generator 524. The component generator 524 is arranged to process the extracted network components 510 for implementing a given functional block, using machine learning, to generate one or more further network components for implementing that functional block. In this way, the component generator 524 may augment the set of network components 510 from which the network composer 520 can compose a neural network 522 when a request 518 is received. The component generator 524 may propose architectures for new network components using neural architecture search (NAS). This may be performed for example by a reinforcement learning agent capable of modifying, removing, adding or replacing layers from within an existing network component 510, as well as modifying or proposing new connection weights. In this way, reinforcement learning may be performed using a reward signal which penalizes changes to the output of the network component, and/or changes to the output of the overall neural network when processing test data. The reward signal may further penalize the number of neurons, encouraging compact network components to be generated. The component generator 524 may additionally, or alternatively, use knowledge distillation or model compression to train a new component, in which parameters of the new component may be determined by minimizing a loss function penalizing a difference between the output of the new network component and the output of an existing network component 510 when processing test data. The same process may be performed for multiple existing network components 510, using multiple new architectures, to generate a large number of new network components for one or more of the common functional blocks.

In an example, a generative neural network is trained, for example using adversarial training, to generate a new network component which mimics the existing network components 510 for implementing a given functional block. The training may use a loss function which penalizes for example the number of neurons and/or the number of layers of the generated network components, encouraging the generative neural network to generate compact network components which are likely to satisfy constraints on computational cost, memory and so on. Trainable parameter values of the resulting new network components may further be refined using e.g. knowledge distillation with a loss function penalizing a difference between the output of the new network component and the output of one or more existing network components 510 when processing test data.

In a further example, a generative neural network for generating new network components may be conditioned on one or more performance values (which are learned during adversarial training by conditioning the generative neural network on the performance data 514 of the network components 510). In this way, given a set of constraints, the generative neural network may generate an appropriate new network component with a high probability of satisfying the constraints. In this way, the conditional generative neural network could be used to store more network components for the network composer 520 to choose from, or alternatively could be executed in response to receiving a request 518, thereby to generate one or more of the components of the synthesized neural network 522 at runtime. In a still further example, a conditional generative neural network may have control over the architecture and trainable parameters of a given number of functional blocks (which may be a condition provided to the generative network for a given subclass), and may be trained using adversarial training to generate and compose corresponding network components, thereby to output an entire neural network 522 in response to a request 518.

The above embodiments are to be understood as illustrative examples. Further embodiments are envisaged. For example, a neural network synthesizer may be arranged to identify common functional blocks between neural networks within a given class but different subclasses. This greatly increases the number of neural networks from which functional blocks can be identified, although certain task-specific blocks may not be identified across the entire class. Furthermore, the various functions of the neural network synthesizer may be performed using respective different systems or devices, possibly remote from one another. For example, the identification and analysis of network components of trained neural networks may be performed by a cloud-based system, and the resulting configuration data and at least some of the network components may be read from cloud-based memory by a client device such as a desktop computer or smartphone, either in response to a request received via the client device, or in the absence of such a request. In the latter case, the client device may be arranged to synthesize a new neural network by composing network components in response to a request received at the client device.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the disclosure, which is defined in the accompanying claims.

What is claimed is:

1. A computer-implemented method comprising:
obtaining a set of trained neural networks for performing a common task and test data for evaluating the performance of the trained neural networks in the set when performing said task;
inspecting the trained neural networks in the set to identify a plurality of functional blocks common to a plurality of the trained neural networks in the set;
for each identified functional block:
extract a respective network component for implementing the functional block within each of at least some of the trained neural networks; and
for each extracted network component:
evaluating performance of the network component when processing the test data; and
storing performance data indicating said performance of the network component when processing the test data;
storing configuration data indicating a configuration of the identified plurality of common functional blocks within said plurality of the trained neural networks;
receiving a request to synthesize a neural network for performing said task subject to a given set of constraints; and
composing a plurality of network components in accordance with the stored configuration data and in dependence on the performance data and the given set of constraints, thereby to synthesize a neural network in accordance with the received request.

2. The computer-implemented method of claim 1, wherein inspecting the trained neural networks in the set comprises processing the test data using each of the trained neural networks.

3. The computer-implemented method of claim 2, wherein processing the test data comprises:
comparing activations of network layers between the trained neural networks when processing a common test data item; and
identifying contiguous groups of layers within at least some of the trained neural networks having consistently alike input activations and output activations to one another.

4. The computer-implemented method of claim 3, wherein comparing the activations of the network layers between the trained neural networks is performed on the basis of a random search or a grid search.

5. The computer-implemented method of claim 3, wherein comparing the activations of the network layers between the trained neural networks uses meta-learning.

6. The computer-implemented method of claim 1, further comprising, for at least one identified functional block, processing the extracted network components for implementing the functional block, using machine learning, to generate one or more further network components for implementing the functional block,
wherein the composed plurality of network components includes at least one of the generated further network components.

7. The computer-implemented method of claim 6, further comprising, for said at least one functional block:
evaluating performance of the one or more further network components when processing the test data; and
storing further performance data indicating said performance of the one or more further network components when processing the test data,
wherein the composing of the plurality of network components is further in dependence on the stored further performance data.

8. The computer-implemented method of claim 6, wherein generating the one or more further network components is performed in response to receiving the request for the neural network.

9. The computer-implemented method of claim 6, wherein the processing of the extracted network components using machine learning uses neural architecture search.

10. The computer-implemented method of claim 6, wherein the processing of the extracted network components using machine learning comprises training a generative model to generate the further network components.

11. The computer-implemented method of claim 10, wherein said training comprises adversarial training.

12. The computer-implemented method of claim 6, wherein said processing of the extracted network components using machine learning uses knowledge distillation or model compression.

13. The computer-implemented method of claim 1, wherein composing the plurality of network components selecting a plurality of the extracted network components, using the stored performance data, for compliance with the given set of constraints.

14. The computer-implemented method of claim 1, wherein the given set of constraints includes at least one of an accuracy constraint, a memory constraint, a processing operation constraint, an execution time constraint, a latency constraint, and an energy consumption constraint.

15. The computer-implemented method of claim 1, wherein
the request indicates an order of priority for the given set of constraints; and
the composing of the plurality of network components is dependent on the indicated order of priority for the given set of constraints.

16. The computer-implemented method of claim 1, wherein the set of trained neural networks in a first set, the method further comprising:
obtaining one or more further sets of trained neural networks, the trained neural networks in each further set configured to performing a respective further common task; and
inspecting the trained neural networks in the one or more further sets to identify that at least some of the plurality of functional blocks are common to at least some of the trained neural networks in the first set and the one or more further sets,
wherein the composed plurality of network components includes at least one network component derived from the trained neural networks in the one or more further sets.

17. The computer-implemented method of claim 15, wherein the request for a neural network is a first request, the method further comprising:
receiving a further request for a neural network for performing a further task subject to a further given set of constraints, wherein the trained neural networks in the one or more further sets are configured to perform said further task; and
composing a further plurality of network components, thereby to synthesize a further neural network in accordance with the received request.

18. The computer-implemented method of claim 1, further comprising training the synthesized neural network using machine learning.

19. A computer-implemented method comprising:
reading, from one or more memory devices:
configuration data indicating a configuration of a plurality of functional blocks common to a plurality of neural networks for performing a task; and
for at least one functional block of said plurality of functional blocks, performance data for one or more network components for implementing said functional block, the performance data for the or each network component indicating a performance of said network component when performing said task;
receiving a request to synthesize a neural network for performing said task subject to a given set of constraints;
selecting, for each functional block of said plurality of functional blocks, a network component for implementing said functional block, wherein the selecting for said at least one functional block is dependent on the given set of constraints and the performance data for the one or more network components for implementing said functional block;
reading, from one or more memory devices, network component data representing the selected network components; and
using the network component data to compose the selected network components in accordance with the configuration data, thereby to synthesize a neural network in accordance with the received request.

20. One or more non-transient storage media comprising computer-readable instructions which, when executed by one or more processors, cause the one or more processors to perform a method comprising:
obtaining a set of trained neural networks for performing a common task and test data for evaluating the performance of the trained neural networks in the set when performing said task;
inspecting the trained neural networks in the set to identify a plurality of functional blocks common to a plurality of the trained neural networks in the set;
for each identified functional block:
extracting a respective network component for implementing the functional block within each of at least some of the trained neural networks; and
for each extracted network component:
evaluating performance of the network component when processing the test data; and
storing performance data indicating said performance of the network component when processing the test data; and
storing configuration data indicating a configuration of the identified plurality of common functional blocks within said plurality of the trained neural networks.
